(19) United States
(12) Patent Application Publication
(10) Pub. No.: US 2013/0019787 A1
(43) Pub. Date: Jan. 24, 2013

(54) All terrian rotary planting device

(71) Applicant: David Gerald Webb, Pineola, NC (US)

(72) Inventor: David Gerald Webb, Pineola, NC (US)

(73) Assignee: DAVID GERALD WEBB, PINEOLA, NC (US)

(21) Appl. No.: 13/374,848

(22) Filed: Mar. 21, 2012

Related U.S. Application Data
(60) Provisional application No. 61/463,297, filed on Feb. 10, 2011.

(51) Int. Cl. A01C 5/06

(52) U.S. Cl. 111/157

(57) ABSTRACT

This planting device has a rotary excavator head instead of a plow to make a furrow The excavator uses a various number of teeth to cut the soil and two flat plates and centrifugal force to distribute the soil evenly around the hole to be excavated for planting. The cutting action of the teeth breaks up the soil into a very fine media. The two flat plates use centrifugal force to distribute it evenly around the hole.

The rotary excavator can be of several different sizes (8-24 inches) on the hand operated models and up to 36 inches on the three point hitch tractor mounted models.

The hand operated model has long handles and wheels to counter act the rotating torque generated by the power head and excavator.

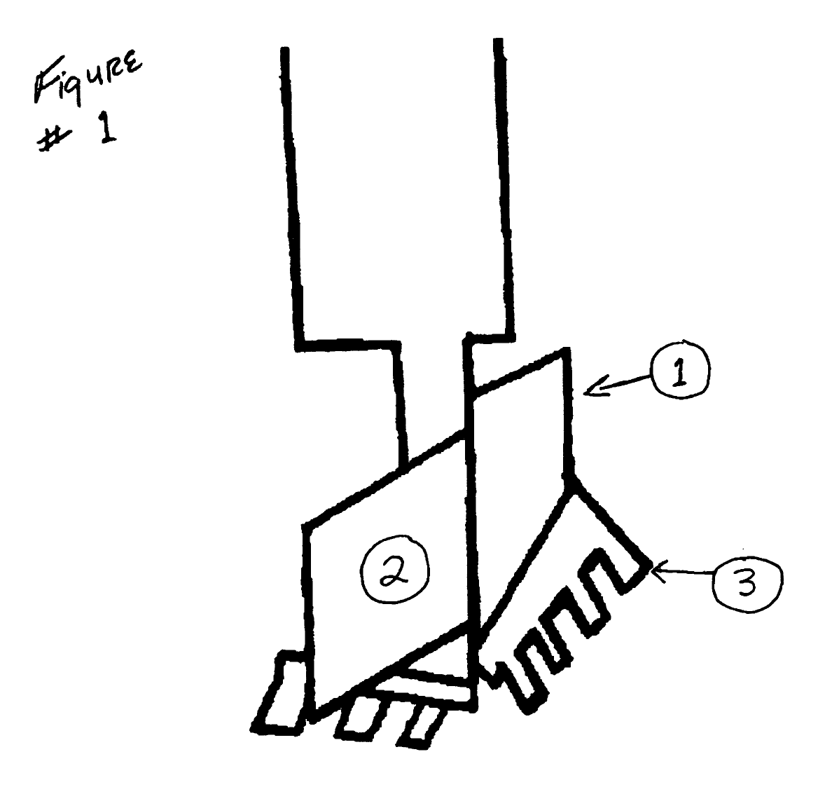

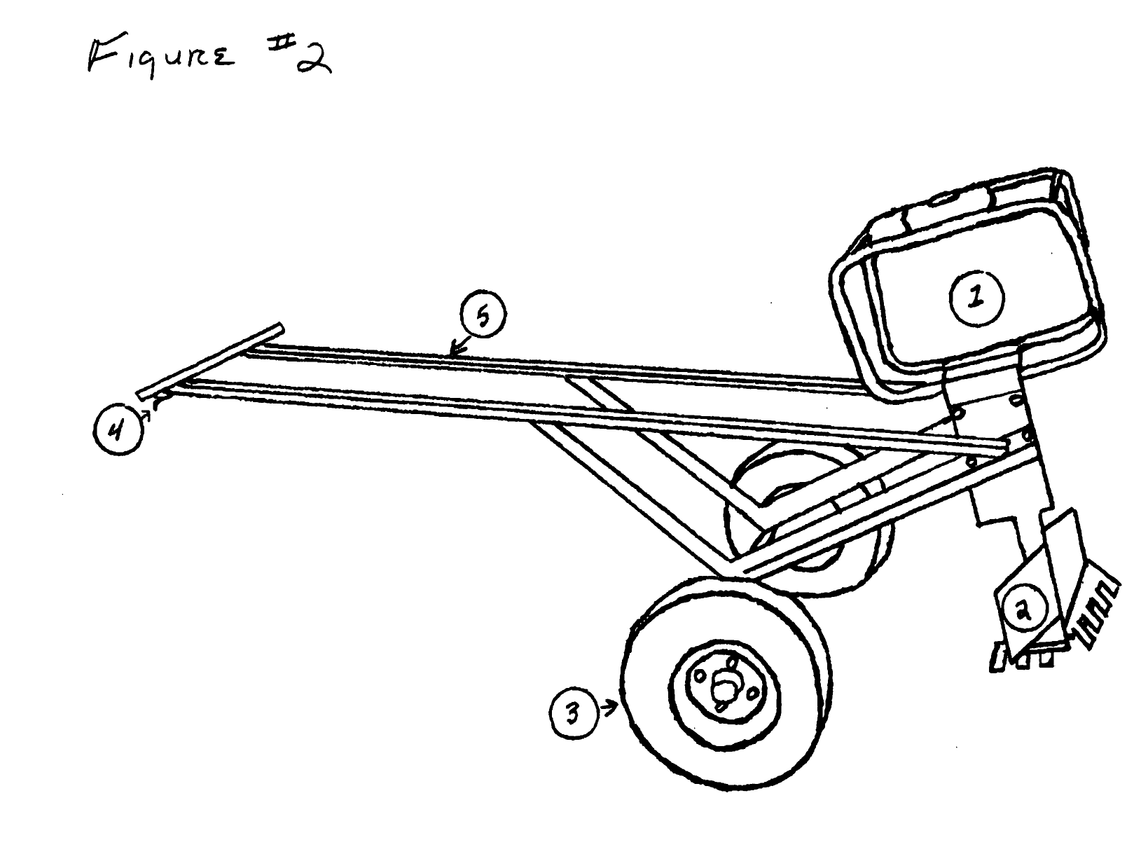

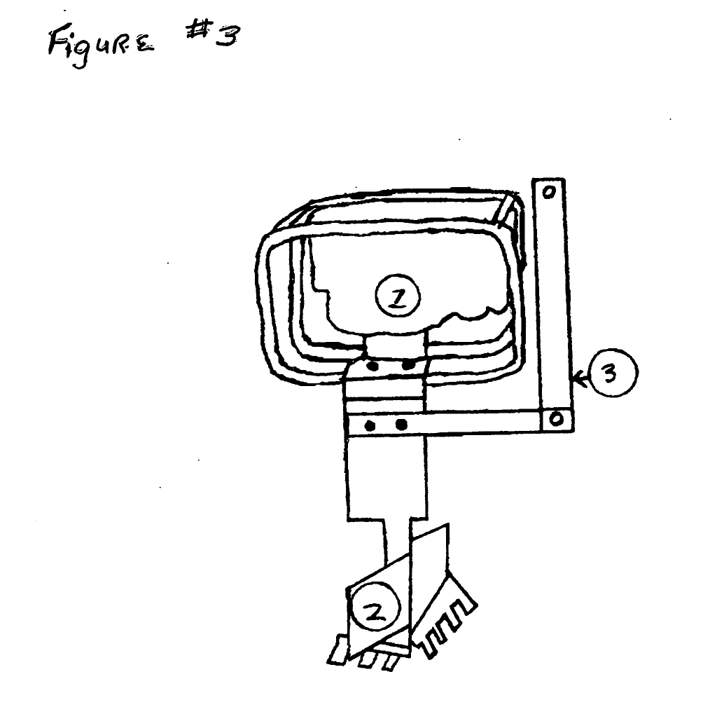

### DISCRIPTION OF DRAWINGS, FIGS. 1 & 2 & 3

Figure #1

#1 Rotary Excavator

#2 Flat plates, for using centrifical force to evenly distribute the media around the hole to be excavated.

#3 Teeth, evenly spaced to break up the media to be excavated.

Figure #2

#1 Power Head, various sizes, 6hp+

#2 Rotary Excavator, various sizes (8 to 24 inches) depending on the hole to be excavated.

#3 Wheels for mobility. The wheels used on this model are 8 inches.

#4 Throttle.

#5 Long Handles for control and to balance out power head and excavator weight. The long handles also counteract the rotating torque of the excavator and power head.

Figure #3

#1 Power head, 6hp+

#2 Rotary excavator.

#3 Three point hitch tractor mount.

### Figure #1

### Specifications

### The All Terain Rotary Planting Device Shone in Figure #1

Figure #1 Shows the Rotary Eccavator. The excavator uses a various number of teeth to cut the soil and two flat plats and centrifugal force to distribute the soil evenly around the hole to be excavated. (most planting devices use a auger to excavate the hole, an auger is used to excavate holes much deeper than is needed for planting.)

### Figure #2

### Specifications

### Hand Operated Model Shone in Figure #2

Figure #1 shows the hand operated model. This model can weigh between 100-400 pounds, depending on the size of the excavator and power head used. The excavator uses various size powerheads from 5-15 horse power. The excavator can be 4-24 inches in diameter and 4-24 inches in height. This model uses wheels and long handles to support the weight and counteract the rotating torque of the machine. It can be used on flat surfaces as well as steep grades and in delicate areas where weight and space are a factor. The machine can be used in cultivated or uncultivated areas, as well as areas where minimum disturbance is required. It works well in new landscaping projects and adding to existing ones, whether large or small.

### Figure #3

### Specifications

### Tractor Mount Shown in Figure #3

Figure #2 shows the tractor mount, which can be powered by the tractor's pto unit or a power head of 5-15 horse power. The excavator can be 4-36 inches in diameter and 4-36 inches in height. The unit can weight 200 pounds or more. This allows the operator to let the tractor carry the weight of the excavator and use the weight of the tractor to counteract the rotating torque of the excavator. The tractor's lift raises and lowers the unit. Raising and lowering the unit allows the operator, while moving the tractor forward between each action, to determine the distance between the hole's to be excavated. The tractor mount is designed for flat drivable locations.

1. This planting device has a rotary excavator head instead of a plow (Figure #1) to make a furrow.
The rotary excavator can be several different sizes (8-24 inches) on the hand operated model
and up to 36 inches on the three point hitch tractor mounted model. It can also be driven by the tractor's pto through a gear box. The power head allows use on tractors without pto power and can be various sizes and horse power depending on the size of the excavator used. The hand operated model has long handles and wheels to counter act the rotating torque of the power head and excavator. The long handles also balance out the weight of the power head and excavator, making it easy to raise and lower the excavator and move on to the next hole to be dug. The wheels make the machine very mobile on all terrain. Planting can be done in fields in straight rows as well as wooded areas that have not been previously culitivated. It can also be used in previously landscaped areas to add additonal shrubs. It works well on both flat planting surfaces and steep grades. The hand operated model can be converted to three point tractor use very easily by removing four bolts and adding the extended throttle cable. The throttle and kill switch mounted on the hand grip or tractor mount give complete control of the power of the machine. The All Terrain Rotary Planting Device uses the wheels and long handles to counter act the rotating torque and weight of the power head and excavator. The weight and lift on the tractor also counter acts the rotating torque and weight of the power head and excavator. This makes excavating a hole for planting much faster, safer, less tiring and more productive. The cutting action of the teeth breaks up the soil into a very fine media. The two flat plates use centrifugal force to distribute it evenly around the hole. This makes filling around the plant very easy with much better soil compaction possible.
